(19) United States
(12) Patent Application Publication
(10) Pub. No.: US 2025/0298395 A1
(43) Pub. Date: Sep. 25, 2025

(54) APPARATUS AND METHOD FOR CONTROLLING GIMBAL

(71) Applicant: AGENCY FOR DEFENSE DEVELOPMENT, Daejeon (KR)

(72) Inventors: Jeongseok KIM, Daejeon (KR); Daeyeon KIM, Daejeon (KR); Chiyeon KIM, Daejeon (KR)

(73) Assignee: AGENCY FOR DEFENSE DEVELOPMENT, Daejeon (KR)

(21) Appl. No.: 18/765,346

(22) Filed: Jul. 8, 2024

(30) Foreign Application Priority Data
Mar. 21, 2024 (KR) 10-2024-0039203

(51) Int. Cl. G05B 19/4155; G03B 17/56

(52) U.S. Cl. CPC G05B 19/4155; G03B 17/561; G05B 2219/34429

(57) ABSTRACT

Provided is a method of controlling a gimbal mounted on a camera, the method including, by a control module, generating a value of a first target rotational force for a servo motor module that transmits a rotational force to the gimbal, based on a value of a sensor output received from a gyro sensor module mounted to be aligned in a direction in which the camera faces and a value of a preset angular velocity of a gimbal platform with which the gimbal is engaged, and, by the control module, applying a value of rotational resistance based on the value of the preset angular velocity of the gimbal platform to the value of the first target rotational force to generate a value of a second target rotational force, and transmitting the value of the second target rotational force to the servo motor module.

### CROSS-REFERENCE TO RELATED APPLICATION

This application is based on and claims priority under 35 U.S.C. § 119 to Korean Patent Application No. 10-2024-0039203, filed on Mar. 21, 2024, in the Korean Intellectual Property Office, the disclosure of which is incorporated by reference herein in its entirety.

### BACKGROUND

### 1. Field

The disclosure relates to an apparatus and method for controlling a gimbal.

### 2. Description of the Related Art

As shooting of personal video content has become popular in recent years, gimbals have been widely used to reduce camera shake. The principle of reducing shake is to drive a servo motor of a gimbal in an opposite direction to rotation caused by movement of a gimbal platform engaged with the gimbal, like a gimbal handle, a drone, etc., to offset the rotation of the platform. Thus, camera shake may be reduced by avoiding rotation in a direction the camera faces as much as possible. To this end, a gyro sensor for measuring an angular velocity may be mounted on the gimbal to be aligned with a gaze line, i.e., the direction the camera faces, thereby measuring the angular velocity (rotation speed and direction) of the gaze line.

Such a camera shake correction technique may be implemented in a manner in which control software embedded in a calculation board mounted on the gimbal drives the servo motor according to a target rotational force calculated to reduce an angular velocity with reference to an angular velocity measured by the gyro sensor. In spite of such control, it may not be possible to completely offset rotation of the gimbal platform due to a lack of precision of the gyro sensor, performance of the servo motor, etc. Therefore, it is necessary to manage the degree of offset as one performance indicator for camera shake correction.

### SUMMARY

Provided is an apparatus and method for controlling a gimbal. However, such a problem is just an example, and the scope of the disclosure is not limited thereto.

Additional aspects will be set forth in part in the description which follows and, in part, will be apparent from the description, or may be learned by practice of the presented embodiments of the disclosure.

According to an aspect of the disclosure, a method of controlling a gimbal mounted on a camera includes, by a control module, generating a value of a first target rotational force for a servo motor module that transmits a rotational force to the gimbal, based on a value of a sensor output received from a gyro sensor module mounted to be aligned in a direction in which the camera faces and a value of a preset angular velocity of a gimbal platform with which the gimbal is engaged, and, by the control module, applying a value of rotational resistance based on the value of the preset angular velocity of the gimbal platform to the value of the first target rotational force to generate a value of a second target rotational force, and transmitting the value of the second target rotational force to the servo motor module.

The generating of the first target rotational force may include receiving the value of the preset angular velocity of the gimbal platform having the gimbal engaged therewith, in a form of a preset data signal, and calculating the value of the first target rotational force, based on the value of the preset angular velocity, by using a linear model having an inverse function.

The transmitting of the second target rotational force to the servo motor module may include calculating the value of rotational resistance, based on an inertial momentum of the gimbal and the value of the preset angular velocity, by using the linear model having the inverse function and generating the value of the second target rotational force, based on a value obtained by subtracting the value of the rotational resistance from the value of the first target rotational force.

The method may further include, by the control module, performing, a camera shake correction performance test mode for the gimbal, in which the performing of the camera shake correction performance test mode includes generating the value of the first target rotational force for a preset period of time and transmitting the value of the second target rotational force to the servo motor module.

According to another aspect of the disclosure, a computer program is provided which is stored on a recording medium for executing on a computing device the above-described method.

According to another aspect of the disclosure, an apparatus for controlling a gimbal mounted on a camera includes a control module configured to control the gimbal, in which the control module is further configured to perform a first operation of generating a value of a first target rotational force for a servo motor module that transmits a rotational force to the gimbal, based on a value of a sensor output received from a gyro sensor module mounted in alignment aligned with a direction in which the camera faces and a value of a preset angular velocity of a gimbal platform with which the gimbal is engaged, and perform a second operation of applying a value of a rotational resistance based on the value of the preset angular velocity of the gimbal platform to the first target rotational force to generate a value of a second target rotational force, and transmitting the value of the second target rotational force to the servo motor module.

The control module may be further configured to receive the value of the preset angular velocity of the gimbal platform having the gimbal engaged therewith, in a form of a preset data signal, and calculate the value of the first target rotational force based on the value of the preset angular velocity, by using a linear model having an inverse function.

The control module may be further configured to calculate the value of the rotational resistance, based on an inertial momentum of the gimbal and the value of the preset angular velocity, by using the linear model having the inverse function and generate the value of the second target rotational force, based on a value obtained by subtracting the value of the rotational resistance from the value of the first target rotational force.

The control module may be further configured to perform a camera shake correction performance test mode for the gimbal, and for a preset period of time, and the camera shake correction performance test mode is a mode in which the first operation and the second operation are performed for a preset period of time.

Other aspects, features and advantages than described above will become apparent from the detailed description, claims, and drawings for carrying out the disclosure below.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a view for describing a method of controlling a gimbal, according to an embodiment of the disclosure;

FIG. 2 is a flowchart illustrating a method of controlling a gimbal, according to an embodiment of the disclosure; and

FIG. 3 is a view for describing a method of controlling a gimbal, according to another embodiment of the disclosure.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items.

The disclosure may have various modifications thereto and various embodiments, and thus particular embodiments will be illustrated in the drawings and described in detail in a detailed description. Effects and features of the disclosure, and methods for achieving them will become clear with reference to the embodiments described later in detail together with the drawings. However, the disclosure is not limited to the embodiments disclosed below and may be implemented in various forms.

Hereinafter, embodiments of the disclosure will be described in detail with reference to the accompanying drawings, and in description with reference to the drawings, the same or corresponding components are given the same reference numerals, and redundant description thereto will be omitted.

In the following embodiments, the terms such as first, second, etc., have been used to distinguish one component from other components, rather than limiting. Singular forms include plural forms unless apparently indicated otherwise contextually. Herein, the terms “include”, “have”, or the like, are intended to mean that there are features, or components, described herein, but do not preclude the possibility of adding one or more other features or components.

In the drawings, the size of components may be exaggerated or reduced for convenience of description. For example, since the size and thickness of each component shown in the drawings are arbitrarily shown for convenience of description, the disclosure is not necessarily limited to the illustrated bar.

In the following embodiments, when a portion, such as a region, a component, a portion or unit, a block, a module, etc., is present on or above another portion, this case may include not only a case where it is directly on the other portion, but also a case where another region, component, portion or unit, block, module, etc., is arranged between the portion and the other portion. When a region, a component, a portion or unit, a block, a module, etc., are connected, this case may include not only a case where a region, a component, a portion or unit, a block, and a module are directly connected, but also a case where they are connected indirectly by another region, component, portion or unit, block, and module arranged therebetween.

Hereinbelow, various embodiments of the disclosure will be described in detail with reference to the accompanying drawings so that those of ordinary skill in the art may easily practice the disclosure.

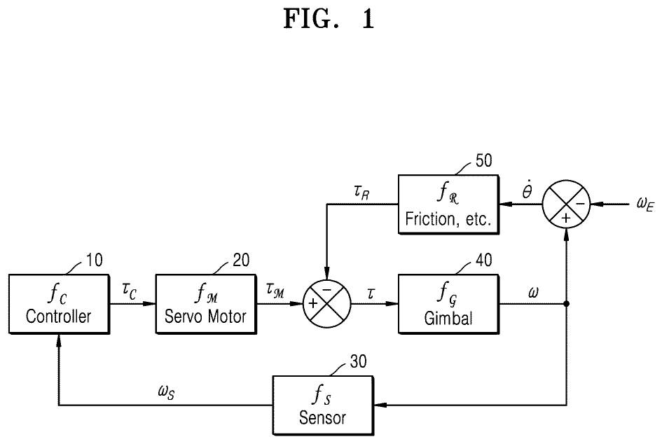

FIG. 1 is a view for describing a method of controlling a gimbal, according to an embodiment of the disclosure.

A method of controlling a gimbal according to an embodiment of the disclosure may be performed by an apparatus for controlling a gimbal. For example, the apparatus for controlling a gimbal according to an embodiment of the disclosure may be provided in the gimbal. For example, an apparatus for controlling a gimbal according to an embodiment of the disclosure may include a memory, a control module, and a communication module. However, the disclosure is not limited thereto, and the apparatus for controlling a gimbal may further include other components or some components may be omitted therefrom. Some components of the apparatus for controlling a gimbal may be separated into a plurality of devices, and a plurality of components may be integrated into one device.

The memory may be a computer-readable recording medium and include a permanent mass storage device such as random access memory (RAM), read only memory (ROM), and a disk drive. A program code for controlling the apparatus for controlling a gimbal may be temporarily or permanently stored in the memory.

The communication module may provide a function for communicating with an external device through a network. For example, a request generated by the control module of the apparatus for controlling a gimbal according to a program code stored in a recording device such as the memory may be transmitted to the external device through the network under control of the communication module. Inversely, a control signal, an instruction, contents, a file, etc., provided under control of a processor of the external device may be received by the apparatus for controlling a gimbal through the communication module via the network.

A communication scheme is not limited and may include short-range wireless communication between devices as well as communications using a communication network (e.g., a mobile communication network, wired Internet, wireless Internet, a broadcast network). For example, the network may include one or more networks among a personal area network (PAN), a local area network (LAN), a campus area network (CAN), a metropolitan area network (MAN), a wide area network (WAN), a broadband network (BBN), Internet, etc. Moreover, the network may include, but not limited to, one or more of network topology including a bus network, a start network, a ring network, a mesh network, a star-bus network, a tree or hierarchical network, etc.

For example, as shown in FIG. 1, the apparatus for controlling a gimbal according to an embodiment of the disclosure may include a control module 10. The apparatus for controlling a gimbal according to an embodiment of the disclosure may control a gimbal 40. For example, the apparatus for controlling a gimbal according to an embodiment of the disclosure may further include a gyro sensor module 30, a servo motor module 20, and a rotational resistance module 50.

The gimbal 40 may be a gimbal device mounted on a stationary or mobile gimbal platform. For example, the gimbal 40 may be mounted on a camera. For example, the gimbal platform may be a platform with which a gimbal is engaged, such as a gimbal handle, a drone, etc.

The gyro sensor module 30 may be mounted to be aligned with a direction in which the camera faces and measure a value of an angular velocity and output the measured value of the angular velocity as a value of a sensor output. For example, the gyro sensor module 30 may be mounted to be aligned with the direction in which the camera faces and measure the value of the angular velocity (e.g., rotation speed and direction) of a gaze line of the camera.

The servo motor module 20 may be a motor device that transmits a rotational force for controlling movement of the gimbal 40 to the gimbal 40. For example, the servo motor module 20 may transmit the rotational force to the gimbal 40 based on a value of a target rotational force received from the control module 10. The rotational resistance module 50 may be a module presenting a rotational resistance force such as a frictional force, etc., of the servo motor.

The control module 10 may control the gimbal 40. The control module 10 may generate a target rotational force for the gimbal 40. The control module 10 may perform a first operation of generating a value of a first target rotational force for the servo motor module 20 that transmits a rotational force to the gimbal 40, based on the value of the sensor output received from the gyro sensor module 30 mounted to be aligned with the direction in which the camera faces and a value of a preset angular velocity of the gimbal platform with which the gimbal 40 is engaged. The control module 10 may also perform a second operation of applying the value of the rotational force based on the value of the preset angular velocity of the gimbal platform to the value of the first target rotational force to generate a value of a second target rotational force and transmitting the value of the second target rotational force to the servo motor module 20.

The control module 10 according to an embodiment of the disclosure may receive the value of the preset angular velocity of the gimbal platform having the gimbal 40 engaged therewith in the form of a preset data signal and calculate the value of the first target rotational force based on the value of the preset angular velocity of the gimbal platform by using a linear module having an inverse function.

The control module 10 according to an embodiment of the disclosure may calculate a value of a rotational resistance based on an inertial momentum of the gimbal 40 and the value of the preset angular velocity of the gimbal platform by using the linear model having the inverse function, and generate the value of the second target rotational force based on a value obtained by subtracting the value of the rotational resistance from the value of the first target rotational force.

The control module 10 according to an embodiment of the disclosure may perform a camera shake correction performance test mode for the gimbal 40. For example, the camera shake correction performance test mode may be a mode that performs the first operation and the second operation for a preset period of time.

The apparatus for controlling a gimbal according to the disclosure may include an input/output interface. The input/output interface may be a means for an interface with an input/output device. For example, the input device may include a keyboard, a mouse, etc., and the output device may include a display for displaying a communication session of an application, etc. In another example, the input/output interface may be a means for an interface with a device in which a function for input and a function for output are integrated into one, such as a touch screen.

A method of controlling a gimbal according to an embodiment of the disclosure may quantify and indicate camera shake correction performance for the gimbal. For example, for a description of the method of controlling a gimbal according to an embodiment of the disclosure, a variable/constant and a function of each module may be defined as below.

TABLE 1
Variable/Constant and Function of Method of Controlling Gimbal

| Symbol | Description |
|---|---|
| f_{C} | Control Module for Generating Target Rotational |
| | Force |
| f_{M} | Servo Motor Module Driven According to Target |
| | Rotational Force Command |
| f_{R} | Module for Rotational Resistance like Frictional |
| | Force of Servo Motor, Etc. |
| f_{G} | Movement Module of Gimbal According to |
| | Rotational Force of Servo Motor |
| f_{S} | Gyro Sensor Module Measuring Angular Velocity of |
| | Gaze Line of Gimbal |
| τ_{C} | Target Rotational Force to be Applied by Control |
| | Module |
| τ_{M} | Rotational Force of Servo Motor Applied According |
| | to Target Rotational Force |
| τ_{R} | Rotational Resistance According to Frictional Force |
| | of Servo Motor, Etc. |
| τ | Resultant Force of Motor Rotation According to |
| | Applied Rotational Force, Frictional Force, Etc. |
| m | Inertial Momentum (Constant) of Gimbal |
| θ | Relative Angle between Gaze Line of Gimbal and |
| | Gimbal Platform |
| \dot{θ} | Relative Angular Velocity between Gaze Line of |
| | Gimbal and Gimbal Platform |
| ω | Inertial Angular Velocity of Gaze Line of Gimbal |
| | (Angular Velocity in Inertial Coordinate System) |
| ω_{S} | Inertial Angular Velocity Measured by Gyro Sensor |
| | Module of Gimbal |
| ω_{E} | Inertial Angular Velocity of Gimbal Platform |
| σ_{S} | Standard Deviation for Angular Velocity ω_{S} during |
| | Test Time |
| σ_{E} | Standard Deviation for Angular Velocity ω_{E} during |
| | Test Time |
| s | Laplace Operator (Complex Variable) |

For example, as shown in FIG. 1, the control module 10 may generate a target rotational force τ_{C} for the servo motor by referring to a gyro sensor output ω_{S}. This may be indicated by Equation 1.

$${τ}_{C} := {f}_{C} ( {ω}_{S} ) \qquad ( 1 )$$

The target rotational force may be input to the servo motor ƒ_{M} and thus the rotational force τi_{M} is applied, but due to the rotational resistance τ_{R} like the frictional force of the servo motor, etc., the resulting rotational force generated in the servor motor may be as given by Equation 2.

$$τ = {τ}_{M} - {τ}_{R} \qquad ( 2 )$$

The rotational resistance due to the frictional force of the servo motor, etc., may be affected by the relative angular velocity \dot{θ} between the gimbal platform and the gimbal, and thus may be expressed as Equation 3.

$${τ}_{R} := {f}_{R} ( \dot{θ} ) \qquad ( 3 )$$

The rotational force generated in the servo motor may be a function τ=m\dot{ω} of an angular acceleration \dot{ω} and the inertial momentum m, and thus may be expressed as Equation 4.

$$ω := {f}_{G} ( τ ) = \frac{τ}{sm} \qquad ( 4 )$$

The camera shake, i.e., the angular velocity ω of the gaze line of the gimbal may be a result ω=ω_{E}+\dot{θ} of overlapping between the angular velocity ω_{E} of the gimbal platform and the relative angular velocity \dot{θ} between the gaze line and the gimbal platform, and thus the relative angular velocity may be expressed as Equation 5.

$$\dot{θ} = ω - {ω}_{E} \qquad ( 5 )$$

A true angular velocity ω may be measured by a gyro sensor, and thus actually obtained information may be a sensor output expressed as below.

$${ω}_{S} := {f}_{S} ( ω )$$

Camera shake correction performance for the gimbal may be the amount of the angular velocity ω_{S} of the gaze line with respect to the amount of an external applied angular velocity ω_{E}, and may be quantified as σₛ/σ_{E} that is a ratio of standard deviations of these two values. Thus, as the value is closer to 0, the camera shake correction performance may be better.

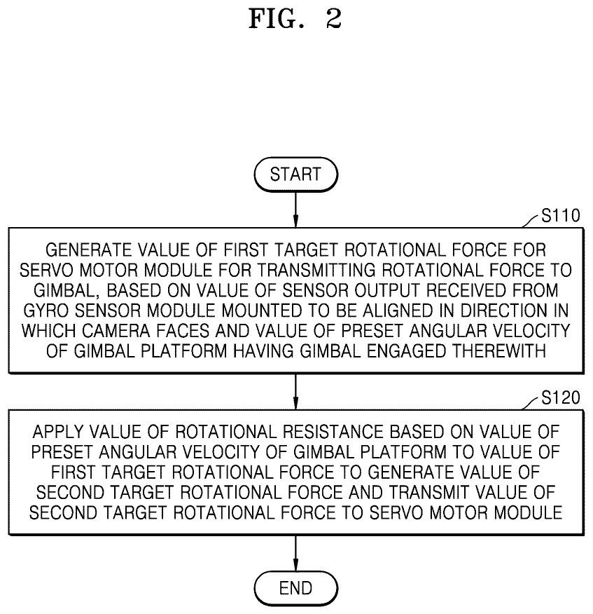

FIG. 2 is a flowchart illustrating a method of controlling a gimbal, according to an embodiment of the disclosure.

Referring to FIG. 2, a method of controlling a gimbal according to an embodiment of the disclosure may include operation S110, performed by a control module, of generating a value of a first target rotational force for a servo motor module that transmits a rotational force to the gimbal, based on a value of a sensor output received from a gyro sensor module mounted to be aligned with a direction in which a camera faces and a value of a preset angular velocity of a gimbal platform having the gimbal engaged therewith.

In operation S120, the control module may apply the value of the rotational force based on the value of the preset angular velocity of the gimbal platform to the value of the first target rotational force to generate a value of a second target rotational force and transmitting the value of the second target rotational force to a servo motor module.

In addition, the generating of the first target rotational force may include receiving the value of the preset angular velocity of the gimbal platform having the gimbal engaged therewith in the form of a preset data signal and calculating the value of the first target rotational force based on the value of the preset angular velocity by using a linear model having an inverse function.

The transmitting of the second target rotational force to the servo motor module may include calculating the value of the rotational resistance based on an inertial momentum of the gimbal and the value of the preset angular velocity by using the linear model having the inverse function and generating the value of the second target rotational force based on a value obtained by subtracting the value of the rotational resistance from the value of the first target rotational force.

The method of controlling a gimbal according to an embodiment of the disclosure may further include an operation, performed by the control module, of performing a camera shake correction performance test mode for the gimbal, and the operation may further include generating the value of the first target rotational force for a preset period of time and transmitting the value of the second target rotational force to the servo motor module.

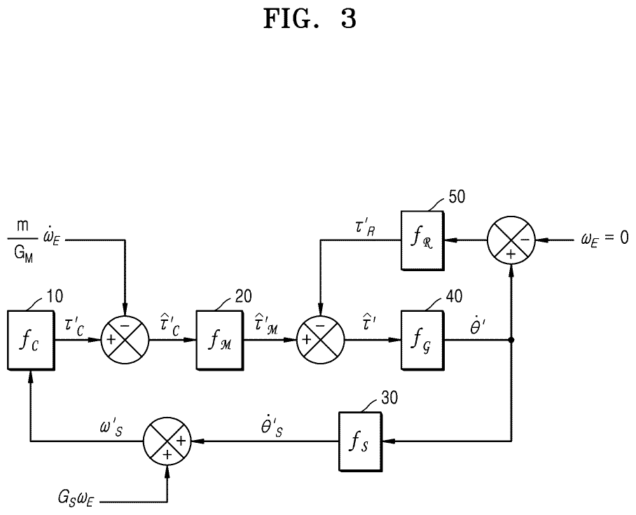

FIG. 3 is a view for describing a method of controlling a gimbal, according to another embodiment of the disclosure.

As an intuitive method for quantifying the camera shake correction performance, a method of identifying a camera shake, i.e., the amount of an angular velocity sensed by the gimbal gyro sensor while rotating the gimbal platform having the gimbal engaged therewith at an angular velocity having controlled direction and magnitude may be considered. To this end, a mechanical structure for simulating a gimbal platform rotating at a precisely controlled angular velocity is required.

The disclosure is directed to an alternative test method capable of reducing the cost of such a structure in quantifying camera shake correction performance. When the method according to the disclosure is used, by applying platform rotation considered for performance measurement to a control module in the form of digital data, instead of putting the gimbal on a static space without movement, a similar result to that using a rotating structure may be obtained.

To measure camera shake correction performance as described above, a mechanical structure for precise driving at a pre-planned angular velocity ω_{E} is required. The disclosure provides a method in which the angular velocity ω_{E} of the platform is applied in the form of a data signal rather than a form of mechanical driving to reduce the corresponding cost. A force τ_{R} that disturbs spatial stabilization control as shown in FIG. 1 may be a function of a relative angular velocity \dot{θ}, which may be expressed as Equation 6 by substituting Equation 4 into Equation 5.

$$\dot{θ} = \frac{τ}{sm} - {ω}_{E} = \frac{\hat{τ}}{sm} \qquad ( 6 )$$

In Equation 6, a newly defined rotational force \hat{τ} may be defined as below.

$$\hat{τ} := τ - m {\dot{ω}}_{E}$$

When a rotational force \hat{τ} is generated in the servo motor, the angular velocity of the corresponding gaze line may be defined as below according to Equation 4.

$$\hat{ω} := {f}_{G} ( \hat{τ} ) = \frac{\hat{τ}}{sm}$$

This is the same as Equation 6, and thus as a result, the angular velocity of the gaze line, which is the same as \dot{θ}, may be generated. Therefore, when platform driving is not considered to reduce the cost, i.e., when ω_{E} is 0, the relative angular velocity is also \dot{θ}, such that the same rotational resistance τ_{R} may be generated according to Equation 3. Thus, a resultant rotational force \hat{τ} may be as below according to Equation 2.

$$\hat{τ} = {\hat{τ}}_{M} - {τ}_{R}$$

In the foregoing equation, the rotational force applied to the servo motor may be defined as below.

$${\hat{τ}}_{M} := {τ}_{M} - m {\dot{ω}}_{E}$$

When a target rotational force for applying the foregoing rotational force is \hat{τ}_{C}, \hat{τ}_{M}=ƒ_{M}(\hat{τ}_{C}) and thus the target rotational force may be expressed as below using the inverse function ƒ_{M}⁻¹.

$${\hat{τ}}_{C} := {f}_{M}^{- 1} ( {\hat{τ}}_{M} )$$

That is, when a target torque for the servo motor is generated as much as \hat{τ}_{C}, the angular velocity of the gaze line of the gimbal may be controlled as \dot{θ}. When ƒ_{M} is regarded as a linear model h_{M} having an inverse function, the target rotational force may be expressed as below.

$${\hat{τ}}_{C} \approx {h}_{M}^{- 1} ( {\hat{τ}}_{M}^{′} ) = {h}_{M}^{- 1} ( {τ}_{M} - m {\dot{ω}}_{E} ) = {h}_{M}^{- 1} ( {τ}_{M} ) - {h}_{M}^{- 1} ( m {\dot{ω}}_{E} )$$

In the foregoing equation, for h_{M}⁻¹(τ_{M})≈ƒ_{M}⁻¹(τ_{M})=τ_{C}, the target rotational force may be expressed as below.

$${\hat{τ}}_{C} \approx {τ}_{C} - {h}_{M}^{- 1} ( m {\dot{ω}}_{E} )$$

By approximating h_{M} of the foregoing equation to a transfer function G_{M}, an approximate value \hat{τ}_{C}′ for \hat{τ}_{C} may be expressed as Equation 7.

$${\hat{τ}}_{C}^{′} := {τ}_{C} - \frac{m {ω}_{E}}{{G}_{M}} \approx {\hat{τ}}_{C} \qquad ( 7 )$$

The rotational force generated by applying the foregoing target rotational force may be defined as below.

$${\hat{τ}}_{M}^{′} := {f}_{M} ( {\hat{τ}}_{C}^{′} ) \approx {\hat{τ}}_{M}$$

The resultant rotational force generated correspondingly may be expressed as Equation 8.

$${\hat{τ}}^{′} := {\hat{τ}}_{M}^{′} - {τ}_{R} \approx \hat{τ} \qquad ( 8 )$$

Thus, an approximate value \dot{θ}′ of \dot{θ} may be generated as below.

$${\dot{θ}}^{′} := {f}_{G} ( {\hat{τ}}^{′} ) \approx \dot{θ}$$

The rotational resistance caused by the foregoing relative angular velocity may be expressed as below.

$${τ}_{R}^{′} := {f}_{R} ( {\dot{θ}}^{′} ) \approx {τ}_{R}$$

Thus, Equation 8 may be modified as below.

$${\hat{τ}}^{′} := {\hat{τ}}_{M}^{′} - {τ}_{R}^{′} \approx \hat{τ}$$

Therefore, when the target rotational force \hat{τ}_{C}′ is applied to the servo motor, the inertial angular velocity as much as the approximate value \dot{θ}′ for the relative angular velocity \dot{θ}, rather than ω of FIG. 1, is generated, such that the gyro sensor output is as expressed below.

$${\dot{θ}}_{S}^{′} := {f}_{S} ( {\dot{θ}}^{′} )$$

However, τ_{C} for generating \hat{τ}_{C}′ as in Equation 7 may be generated by inputting ω_{S} to the control module as in Equation 1. Thus, to infer ω_{S}, this may be expressed with a linear model h_{S} for the gyro sensor ƒ_{S} as below.

$${ω}_{S} = {f}_{S} ( ω ) = {f}_{S} ( \dot{θ} + {ω}_{E} ) \approx {h}_{S} ( \dot{θ} + {ω}_{E} ) = {h}_{S} ( \dot{θ} ) + {h}_{S} ( {ω}_{E} )$$

In the foregoing equation, h_{S}(\dot{θ})≈ƒ_{S}(\dot{θ})≈ƒ_{S}(\dot{θ}′), such that an approximate value ω_{S}′ for ω_{S} may be defined as below.

$${ω}_{S}^{′} := {\dot{θ}}_{S}^{′} + {h}_{S} ( {ω}_{E} ) \approx {ω}_{S}$$

Considering the transfer function G_{S} as the model h_{S} for the gyro sensor, this may be defined as Equation 9.

$${ω}_{S}^{′} := {\dot{θ}}_{S}^{′} + {G}_{S} {ω}_{E} \qquad ( 9 )$$

Thus, by inputting ω_{S}′ in place of the gyro sensor output \dot{θ}_{S}′ into a controller, the approximate value \hat{τ}_{C}′ for the target rotational force \hat{τ}_{C} may be generated as below.

$${τ}_{C}^{′} := {f}_{C} ( {ω}_{S}^{′} )$$

Thus, Equation 7 may be expressed as Equation 10.

$${\hat{τ}}_{C}^{′} := {τ}_{C}^{′} - \frac{m {\dot{ω}}_{E}}{{G}_{M}} \approx {\hat{τ}}_{C} \qquad ( 10 )$$

For example, as shown in FIG. 3, the method of controlling a gimbal according to an embodiment of the disclosure may calculate an angular acceleration and an angular velocity of a pre-planned platform together with a transfer function for the servo motor and the gyro sensor and an inertial momentum, to obtain Equation 9 and Equation 10. That is, G_{S}ω_{E} and m\dot{ω}_{E}/G_{M} may be respectively applied to an input unit and an output unit of the control module 10. In this case, when a standard deviation of ω_{S}′ measured during a test time is σₛ′, space stabilization performance may be calculated as σₛ′/σ_{E}. Applied signals of G_{S}ω_{E} and m\dot{ω}_{E}/G_{M} may not be values that change during a control operation and thus may be preset in the control module. For example, by adding a camera shake correction performance test mode to the control module and performing the corresponding mode, two applied signals may be applied during a specific time to drive a gimbal.

The apparatus and/or system described above may be implemented by a hardware component, a software component, and/or a combination of the hardware component and the software component. The apparatus and components described in the embodiments may be implemented using one or more general-purpose or special-purpose computers such as, for example, a processor, a controller, an arithmetic logic unit (ALU), a digital signal processor, a microcomputer, a field programmable gate array (FPGA), a programmable logic unit (PLU), a microprocessor, or any other device capable of executing and responding to instructions. A processing device may execute an operating system (OS) and one or more software applications running on the OS. The processing device may access, store, manipulate, process, and generate data in response to execution of software. For convenience of understanding, it is described that one processing device is used, but those of ordinary skill in the art would recognize that the processing device includes a plurality of processing components and/or a plurality of types of processing components. For example, the processing device may include a plurality of processors or one processor and one controller. Alternatively, other processing configurations such as parallel processors may be possible.

Software may include a computer program, a code, an instruction, or a combination of one or more thereof, and may configure a processing device to operate as desired or independently or collectively instruct the processing device. The software and/or data may be permanently or temporarily embedded in any type of machine, component, physical device, virtual equipment, computer storage medium or device, or signal wave to be transmitted, so as to be interpreted by or to provide instructions or data to the processing device. The software may be distributed over computer systems connected through a network and may be stored or executed in a distributed manner. The software and data may be stored in one or more computer-readable recording media.

The method according to the embodiments may be implemented in the form of program commands that can be executed through various computer components and recorded in a computer-readable recording medium. The computer-readable recording medium may include a program command, a data file, a data structure, etc., alone or in a combined manner. The program command recorded in the medium may be a program command specially designed and configured for the embodiments or a program command known to be used by those skilled in the art of the computer software field. Examples of the computer-readable recording medium may include magnetic media such as hard disk, floppy disk, and magnetic tape, optical media such as compact disk read only memory (CD-ROM) and digital versatile disk (DVD), magneto-optical media such as floptical disk, and a hardware device especially configured to store and execute a program command, such as read only memory (ROM), random access memory (RAM), flash memory, etc. Examples of the program command may include not only a machine language code created by a complier, but also a high-level language code executable by a computer using an interpreter. The foregoing hardware device may be configured to be operated as at least one software module to perform an operation of the embodiments, or vice versa.

While embodiments have been described by the limited embodiments and drawings, various modifications and changes may be made from the disclosure by those of ordinary skill in the art. For example, even when described techniques are performed in a sequence different from the described method and/or components such as systems, structures, devices, circuits, etc. are combined or connected differently from the described method, or replaced with other components or equivalents, an appropriate result may be achieved.

Therefore, other implementations, other embodiments, and equivalents to the claims may also fall within the scope of the claims provided below.

According to an embodiment of the disclosure as described above, the camera shake correction performance may be quantified and measured. Moreover, by applying the angular velocity of the platform in the form of a data signal rather than mechanical driving, the cost for measurement of the camera shake correction performance may be reduced efficiently. However, the scope of the disclosure is not limited by these effects.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. A method of controlling a gimbal mounted on a camera, the method comprising:
by a control module, generating a value of a first target rotational force for a servo motor module that transmits a rotational force to the gimbal, based on a value of a sensor output received from a gyro sensor module mounted to be aligned in a direction in which the camera faces and a value of a preset angular velocity of a gimbal platform with which the gimbal is engaged; and
by the control module, applying a value of rotational resistance based on the value of the preset angular velocity of the gimbal platform to the value of the first target rotational force to generate a value of a second target rotational force, and transmitting the value of the second target rotational force to the servo motor module.

2. The method of claim 1, wherein the generating of the first target rotational force comprises:
receiving the value of the preset angular velocity of the gimbal platform having the gimbal engaged therewith, in a form of a preset data signal; and
calculating the value of the first target rotational force, based on the value of the preset angular velocity, by using a linear model having an inverse function.

3. The method of claim 2, wherein the transmitting of the value of the second target rotational force to the servo motor module comprises:
calculating the value of rotational resistance, based on an inertial momentum of the gimbal and the value of the preset angular velocity, by using the linear model having the inverse function; and
generating the value of the second target rotational force, based on a value obtained by subtracting the value of rotational resistance from the value of the first target rotational force.

4. The method of claim 3, further comprising performing, by the control module, a camera shake correction performance test mode for the gimbal,
wherein the performing of the camera shake correction performance test mode comprises generating the value of the first target rotational force for a preset period of time and transmitting the value of the second target rotational force to the servo motor module.

5. A computer program stored on a recording medium for executing on a computing device the method according to claim 1.

6. An apparatus for controlling a gimbal mounted on a camera, the apparatus comprising a control module configured to control the gimbal,
wherein the control module is further configured to:
perform a first operation of generating a value of a first target rotational force for a servo motor module that transmits a rotational force to the gimbal, based on a value of a sensor output received from a gyro sensor module mounted in alignment aligned with a direction in which the camera faces and a value of a preset angular velocity of a gimbal platform with which the gimbal is engaged; and
perform a second operation of applying a value of a rotational resistance based on the value of the preset angular velocity of the gimbal platform to the first target rotational force to generate a value of a second target rotational force, and transmitting the value of the second target rotational force to the servo motor module.

7. The apparatus of claim 6, wherein the control module is further configured to receive the value of the preset angular velocity of the gimbal platform having the gimbal engaged therewith, in a form of a preset data signal, and calculate the value of the first target rotational force based on the value of the preset angular velocity, by using a linear model having an inverse function.

8. The apparatus of claim 7, wherein the control module is further configured to:
calculate the value of the rotational resistance, based on an inertial momentum of the gimbal and the value of the preset angular velocity, by using the linear model having the inverse function; and
generate the value of the second target rotational force, based on a value obtained by subtracting the value of the rotational resistance from the value of the first target rotational force.

9. The apparatus of claim 8, wherein the control module is further configured to perform a camera shake correction performance test mode for the gimbal, and
the camera shake correction performance test mode is a mode in which the first operation and the second operation are performed for a preset period of time.
